(19) United States
(12) Patent Application Publication
(10) Pub. No.: US 2013/0103811 A1
(43) Pub. Date: Apr. 25, 2013

(54) METHOD FOR PROVIDING A COMMUNICATION FOR AT LEAST ONE DEVICE

(71) Applicants: Volker Blaschke, Ludwigsburg (DE); Juergen Schirmer, Heidelberg (DE); Timo Lothspeich, Gerlingen (DE); Tobias Lorenz, Schwieberdingen (DE); Clemens Schroff, Kraichtal (DE)

(72) Inventors: Volker Blaschke, Ludwigsburg (DE); Juergen Schirmer, Heidelberg (DE); Timo Lothspeich, Gerlingen (DE); Tobias Lorenz, Schwieberdingen (DE); Clemens Schroff, Kraichtal (DE)

(21) Appl. No.: 13/643,835

(22) PCT Filed: Apr. 6, 2011
(86) PCT No.: PCT/EP2011/055302

§ 371 Date: Jan. 2, 2013

(30) Foreign Application Priority Data
Apr. 27, 2010 (DE) 102010028225.1

(51) Int. Cl. G06F 15/177

(52) U.S. Cl. CPC G06F 15/177
USPC 709/221

(57) ABSTRACT

A method for providing a communication for at least one device that is provided for a motor vehicle and is linked via a network of the motor vehicle to at least one further device, where data between the at least one device and the at least one further device are exchanged via an Internet Protocol. Also a device and a network are provided.

### FIELD OF THE INVENTION

The present invention relates to a method for providing a communication for at least one device, and to a device and a network.

### BACKGROUND INFORMATION

Control units organized by functional domains are used in a motor vehicle. These control units communicate with one another via a shared communications technology. A CAN bus (Controller Area Network) or a FlexRay bus are typically used. In the case of bus systems or bus configurations used for motor vehicles, a physical separation of communication domains allocated to the functional domains is carried out. To nevertheless render possible a communication among the communication domains, gateways or protocol converters are used.

In contrast, in IP (Internet Protocol) networks, merely one logical separation is typically to be carried out. To this end, one portion of the IP address of a communication node can be designated as the network address. Nodes having the same network address can implement a communication within the thereby formed IP subnet. Thus, a communication can also take place among a plurality of subnets.

### SUMMARY

In accordance with the present invention, an example method is provided which may be used to specify domains for devices located in a motor vehicle that communicate with one another via a network, and to implement an IP subnet mapping of the specified domains in accordance with an addressing based on the Internet Protocol (IP). It is provided, inter alia, that at least one device be assigned to at least one subnet. The devices of the network may be assigned to a plurality of functional groups, each functional group being assigned to a subnet. If one device is assigned to a plurality of functional groups and thus subnets, then it has an IP address for each subnet. A device within the network and/or the subnet may also be referred to as node or station.

The example embodiment of the present invention makes it possible to take into account, inter alia, that when the existing networking technology employing CAN or FlexRay buses, and including an Ethernet network, is changed, an assignment of the previous functional domains of devices to IP subnets takes place.

Alternatively, an assignment may also be made in accordance with functional groups. For example, the devices configured as sensors and the devices configured as actuators may be assigned to separate subnets taking into account the functions thereof.

In both cases, this eliminates the need for the gateways, respectively protocol translators used in known methods heretofore. Given a normal use of switches, a logical separation does not result in an increased communication traffic volume at a node and thus at a device of a subnet of the network. The data are typically only transmitted to the nodes and thus devices assigned to the respective IP subnet, thereby limiting the communication traffic volume on the relevant subnet to the correspondingly assigned relevant devices.

In one example embodiment of the present invention, a device may be in the form of a control unit (ECU) that is designed to control functions of at least one component of the motor vehicle and thus for controlling and/or regulating, and is located in the motor vehicle. This type of control unit may be assigned to at least one subnet and thus also to a plurality of subnets of the entire network. The control unit may have its own address, typically in the form of an IP address, allocated thereto for each subnet.

This eliminates the need for configuring the protocol converter because the nodes, respectively stations of the network may be assigned further addresses of other subnets in accordance with the requirements. Thus, when new cross-domain functions are introduced, it is only necessary to adapt the respective device, normally in the form of a control unit, however, not additionally the protocol converter.

The described allocation is carried out on the basis of IP technology and is thus independent of a protocol that underlies a second layer, respectively security layer for a data communication (data link layer) in accordance with the OSI layers, respectively OSI reference model. Thus, it is unimportant whether Ethernet, MOST (Media Oriented Systems Transport) or other IP-capable transmission methods are used in the network.

In the ISO/OSI model, the Internet Protocol resides in the third layer, i.e., in the network layer. The second layers (data link layers) typically provided are the Ethernet, MOST and wireless LAN. Generally, the Internet Protocol (IP) is used in two versions. The Internet Protocol of version 4 (IPv4) uses addresses of 32-bit length. The Internet Protocol of version 6 (Ipv6) uses addresses of 128-bit length. Independently thereof, each IP address has two parts, namely the host address and the network address. All nodes or stations, and thus devices in the same subnet may communicate with one another via the network addresses. The host address is used for identifying the device.

In one possible example embodiment, a motor vehicle topology and, accordingly, a motor vehicle network may include four domains and thus functional groups, respectively subnets, namely for the power train, the chassis, the body, as well as passenger compartment (body and cabin) and for auxiliary devices (comfort). If this topology is implemented in IP subnets, the allocation shown, for example, in Table 1 may be made in accordance with CIDR (Classless Inter-Domain Routing).

TABLE 1

| IP subnet | |
|---|---|
| (CIDR notation) | Domains |
| 10.0.0.0/8 | private address space of the |
| | entire network for the motor |
| | vehicle |
| 10.1.0.0/16 | private address space of a subnet |
| | for the power train |
| 10.2.0.0/16 | private address space of a subnet |
| | for the chassis |
| 10.3.0.0/16 | private address space of a subnet |
| | for the body and passenger |
| | compartment |
| 10.4.0.0/16 | private address space of a subnet |
| | for auxiliary devices |

In this example, the IP subnet 10.0.0.0/8 provided by the IANA (Internet Assigned Numbers Authority) for private networks is used. This network is partitioned into 256 subnets, four of which are used for functional domains in accordance with the functional groups and thus subnets specified in Table 1.

In each of these subnets, 16 bits still remain for addressing the particular nodes and thus devices. Thus, nearly 65,536 IP addresses are possible in each domain, usually functional domain.

A device may be represented as a node of the network in a plurality of subnets and thus have a plurality of IP addresses. In one embodiment, each device may have one IP address of each of the 256 possible IP subnets.

To communicate, each device needs at least one IP address. It is an integral part of each received or transmitted data packet (IP packet) of a device. In addition, each device has an IP address for a subnet. The present invention may be used for any type of IP networks in motor vehicles.

Using the IP, respectively Internet Protocol for the network, merely one logical separation is performed for an addressing of devices. To this end, one portion of the IP address of a communication node may be designated as the network address. Devices having the same network address may implement a communication within the thereby formed IP subnet. If a communication is to take place in a plurality of subnets for one device, then a plurality of addresses may be allocated to this device.

The example network according to the present invention may have at least one example device according to the present invention. This at least one device and thus the network are designed for implementing all steps of the presented method. Individual steps of this method may also be carried out by the at least one device of the network. In addition, functions of the network or functions of the at least one device may be implemented as steps of the method. Moreover, steps of the method may be realized as functions of at least one device or of the entire network.

Further advantages and example embodiments of the present invention will become apparent from the description and the figures.

It is understood that the aforementioned features and those explained below may be used not only in the particular stated combination, but also in other combinations or alone, without departing from the scope of the present invention.

### BRIEF DESCRIPTION OF THE DRAWINGS

FIG. 1 shows in a schematic representation an example of a structure of IPv4 addresses which are configured in accordance with the Internet Protocol of version 4.

FIG. 2 shows in a schematic representation an example of a header data field configured in accordance with the Internet Protocol of version 4.

FIG. 3 shows in a schematic representation an example of a header data field configured in accordance with the Internet Protocol of version 6.

FIG. 4 shows in a schematic representation a specific embodiment of a network according to the present invention.

### DETAILED DESCRIPTION OF EXAMPLE EMBODIMENTS

The present invention is schematically illustrated in the figures on the basis of specific example embodiments and is described in detail in the following with reference to the figures.

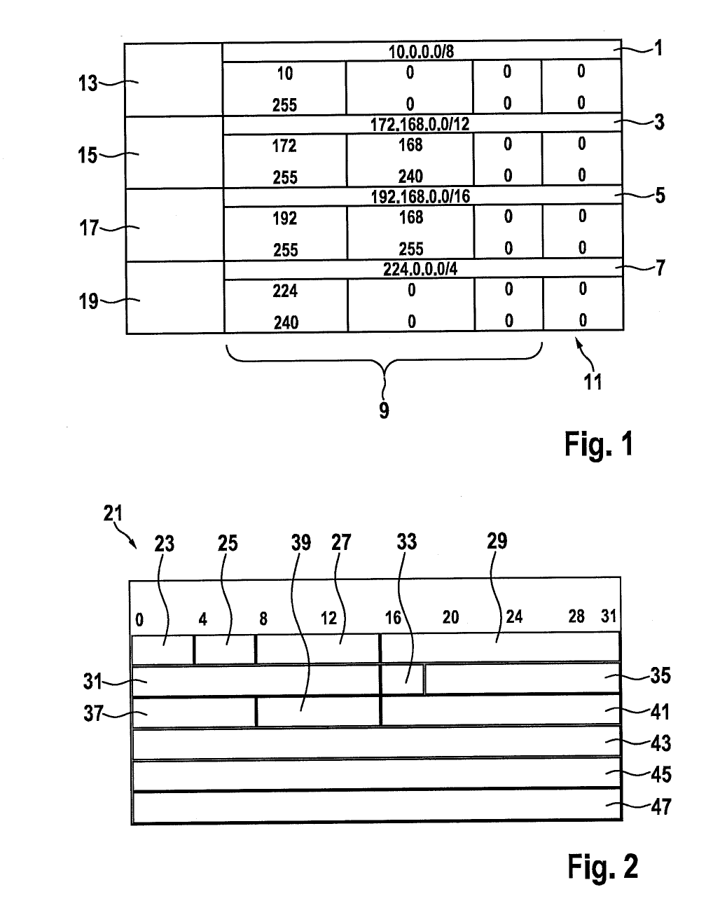

In a schematic representation, FIG. 1 shows a diagram of a partitioning of different addresses 1, 3, 5, 7, which are provided here as IPv4 addresses for an Internet Protocol in accordance with version 4 and which each include a subnet portion 9 and a host, respectively data provider portion 11. In this connection, it is provided that addresses 1, 3, 5, 7 be allocated in accordance with the Classless Inter-Domain Routing method, in short CIDR, and thus in accordance with a method for cross-domain information transmission.

In a practical implementation of the method according to the present invention for providing a network for a motor vehicle, the entire network is structured, respectively partitioned into four subnets 13, 15, 17, 19.

A first network 13 is segmented as what is generally referred to as a class A private network and is assigned address 1 “10.0.0.0./8” having a range-of values of 0 to 255 per block. A second subnet 15 is configured in the described specific embodiment of the present invention as a class B private network, which is assigned address 3 “172.168.0.0/12” here. A third subnet 17 is configured as a class C private network and has address 5 “192.168.0.0/16.” Second subnet 15 and third subnet 17 likewise have range of values 0 through 266 assigned thereto per block. A fourth subnet 19 is configured as a class D private network and has address 7 “224.0.0.0./4,” as well as a range of values 0 through 240 per block.

In a schematic representation, FIG. 2 shows an example of a header data field 21 configured as an IPv4 header data field and thus a header as is used in an Internet Protocol of version 4 (IPv4) to introduce a data packet (frame) to be sent.

This header data field 21 having a width of 32 bits contains information about a version 23 of header data field 21 having a width of 4 bits, information on a length 25 of the data packet having a width of 4 bits, this length 25 also being shortened as IHL for IP header length, information on a service type 27 (TOS, Type of Service) having a width of 8 bits, as well as information on a total length 29 of the data packet having a width of 16 bits.

In addition, header data field 21 includes an identification 31 having a width of 16 bits, a control switch 33 (flag) having a width of 3 bits and information about a fragmentation 35 (fragment offset) having a width of 13 bits. Moreover, information about a lifetime 37 (Time to Live, TTL) of the data packet having a width of 8 bits, information about Internet Protocol 39 used within the scope of the present invention and a checksum 41 having a width of 16 bits are provided. Header data field 21 described here in accordance with Internet Protocol 39 of version 4 also includes information about a source address 43, a destination address 45 and, in some instances, at least information about further options 47, which each have a width of 32 bits.

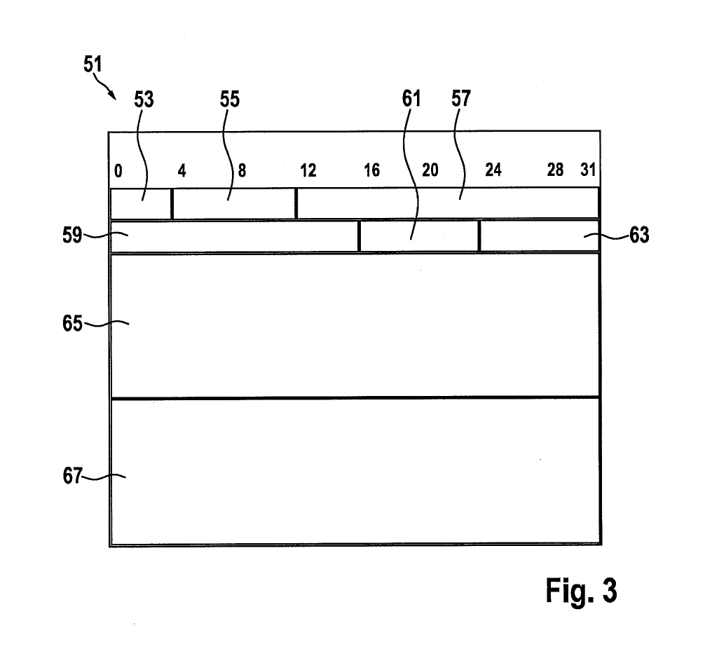

A header data field 51 for a data packet (frame) of an Internet Protocol of version 6 (IPv6) is shown schematically in FIG. 3. This header data field 51 configured as an IPv6 header data field contains information about a version 53 having a width of 4 bits, information about a priority allocation 55 (traffic class) having a width of 8 bits, information about a flow value 57 (flow label) having a width of 20 bits, information about a length 59 of a content of the data packet configured as an IPv6 data packet having a width of 16 bits, information for identification 61 of a subsequent header data field having a width of 8 bits, and information on a maximum number of intermediate steps 63 (hop limit) that the assigned data packet is allowed to execute via a router, given a width of 8 bits. Moreover, illustrated IPv6 header data field 51 includes a source address 65 and a destination address 67, which each have a width of 128 bits.

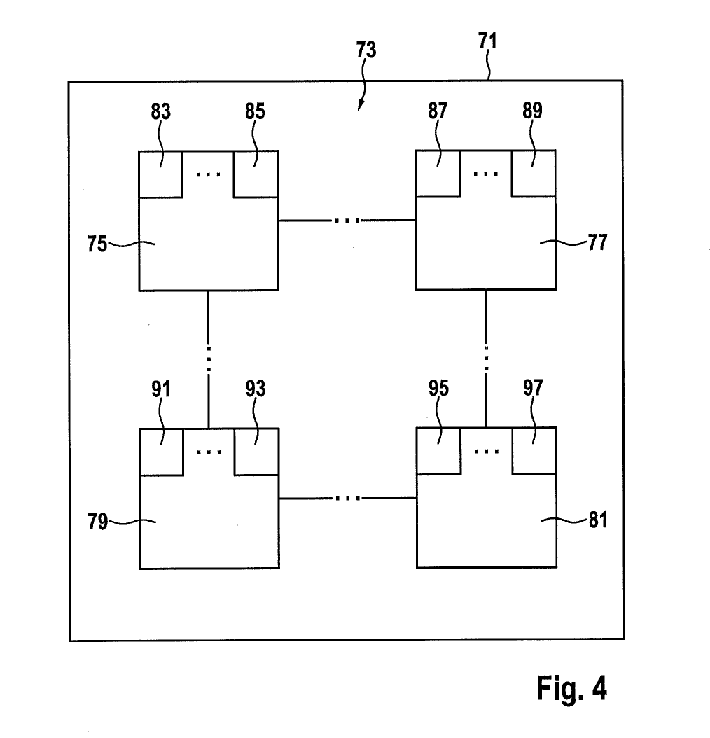

In a schematic representation, FIG. 4 shows a motor vehicle 71 that encompasses a specific embodiment of a network 73 according to the present invention. This network 73 has a plurality of interconnected specific embodiments of devices 75, 77, 79, 81 according to the present invention that are located in motor vehicle 71, at least one of these devices 75, 77, 79, 81 being in the form of a control unit (ECU) for at least one component of motor vehicle 71 (not shown here). Within network 73, illustrated devices 75, 77, 79, 81 exchange data and thus information via an Internet Protocol.

In addition, devices 75, 77, 79, 81 may be configured as sensors for recording states of operating parameters of the motor vehicle or as actuators for acting upon components of the motor vehicle. It is also possible that at least one device 75, 77, 79, 81 described here not be configured as a control unit, but as a communication device, respectively antenna, radio or navigation system, which may be configured for exchanging data with the outside world and/or the driver which may, as the case may be, be based on the exchanged data.

A first address 83 configured as an Internet address, as well as at least an n-th address 85 configured as an Internet address are assigned to a first device 75. A first address 89 configured as an Internet address 87, as well as at least an n-th address 89 configured as an Internet address are likewise assigned to second device 77. A first address 91 configured as an Internet address, as well as at least an n-th address 93 configured as an Internet address are assigned to a third device 79. A first address 95 configured as an Internet address, as well as an n-th address 97 configured as an Internet address are assigned to a fourth device 81.

The allocation of a plurality of addresses 83, 85, 87, 89, 91, 93, 95, 97 for a device 75, 77, 79, 81 as provided within the scope of a specific embodiment of the example method according to the present invention makes it possible for each device 75, 77, 79, 81 to be assigned to various subnets and thus functional groups of entire network 73. An address 83, 85, 87, 89, 91, 93, 95, 97 of a particular device 75, 77, 79, 81 is used as a source address and/or destination address independently of the subnet within which a data packet is exchanged among devices 75, 77, 79, 81. The functional properties of devices 75, 77, 79, 81 are taken into account in the allocation of devices 75, 77, 79, 81 to various subnets and thus functional groups.

1-10. (canceled)

11. A method for providing a communication for at least one device that is provided for a motor vehicle, the method comprising:
linking the at least one device via a network of the motor vehicle to at least one further device; and
exchanging data between the at least one device and the at least one further device via an Internet Protocol.

12. The method as recited in claim 11, wherein at least one address is assigned to the at least one device, the at least one address of the at least one device being partitioned into at least one host address and at least one network address.

13. The method as recited in claim 11, wherein the network is partitioned into a plurality of subnets, the at least one device being assigned to at least one subnet.

14. The method as recited in claim 13, wherein a domain is assigned to the at least one device for each subnet.

15. The method as recited in claim 13, wherein at least one device is assigned to at least one functional group, each functional group being assigned to a subnet.

16. The method as recited in claim 13, wherein data, which are only provided for one subnet, are transmitted to at least one device that is assigned to the particular subnet.

17. The method as recited in claim 11, wherein the method is implemented for at least one device configured as a control unit, the at least one device being configured for controlling at least one component of the motor vehicle.

18. The method as recited in claim 11, wherein a network is operated for a motor vehicle, at least two devices, which are provided for the motor vehicle, being interconnected via the network.

19. A device for a motor vehicle, the device to be linked via a network of the motor vehicle to at least one further device, which is provided for the motor vehicle, the device being configured for exchanging data via an Internet Protocol with at least one further device.

20. A network for a motor vehicle which is configured for linking at least one device for the motor vehicle, the network, being provided with at least one further device for the motor vehicle, the at least one device and the at least one further device being configured for exchanging data via an Internet Protocol.
